(19) United States
(12) Patent Application Publication
(10) Pub. No.: US 2020/0288646 A1
(43) Pub. Date: Sep. 17, 2020

(54) POD LIGHTING SYSTEM FOR PLANTS

(71) Applicant: LESLIE DAVID HOWE, Atlanta, GA (US)

(72) Inventor: LESLIE DAVID HOWE, Ottawa (CA)

(73) Assignee: SOUTHPAC TRUST INTERNATIONAL INC., TRUSTEE OF THE LDH TRUST, Rarotonga (CK)

(21) Appl. No.: 16/752,659

(22) Filed: Jan. 26, 2020

Related U.S. Application Data
(60) Provisional application No. 62/817,728, filed on Mar. 13, 2019.
(60) Provisional application No. 62/884,811, filed on Aug. 9, 2019.

(51) Int. Cl. A01G 9/24; F21S 4/28; F21V 29/70; F21S 8/06; F21V 21/36; F21V 7/10; F21V 17/10; A01G 9/14

(52) U.S. Cl. CPC A01G 9/249; F21S 4/28; F21V 29/70; F21S 8/061; F21Y 2115/10; F21V 7/10; F21V 17/10; A01G 9/1438; A01G 9/24; F21V 21/36

(57) ABSTRACT

In an example embodiment of the disclosed technology, a modular pod lighting system for plants may comprise a light containment enclosure, which may further comprise a light panel with one side configured to emit light, wherein the light panel may be configured to hang from an above structural element in a relatively horizontal orientation. The modular pod lighting system for plants may further comprise side reflection curtains attached to opposing edges of the light panel, wherein the reflection curtains may extend downwards away from the light panel. The light containment enclosure may be configured to partially enclose plants therein, and wherein light emitted from the light panel may be partially contained and recycled within the light containment enclosure. The light containment enclosure may further comprise bottom reflectors disposed on top of plant containment devices.

### CROSS REFERENCE TO RELATED APPLICATIONS

This application claims the benefit of U.S. Provisional Patent Application No. 62/817,728 filed Mar. 13, 2019 entitled “LIGHTING AND REFLECTION SYSTEMS FOR PLANTS”, the contents of which are incorporated by reference in their entirety as if set forth in full.

This application claims the benefit of U.S. Provisional Patent Application No. 62/884,811 filed Aug. 7, 2019 entitled “POD LIGHTING SYSTEM FOR PLANTS”, the contents of which are incorporated by reference in their entirety as if set forth in full.

### TECHNICAL FIELD

This disclosure generally relates to light reflectors and apparatuses for plants.

### BACKGROUND

There is a continuing need for horticulture systems that can save energy and increase yields.

### BRIEF DESCRIPTION OF THE FIGURES

FIG. 1 shows a top perspective of an example embodiment of a modular pod lighting system for plants, wherein the modular pod lighting system for plants is lowered into a normal operating position.

FIG. 2 shows a top perspective view of the example embodiment of a modular pod lighting system for plants as shown in FIG. 1, wherein the modular pod lighting system for plants is raised above its normal operating position.

FIG. 3A shows a top perspective exploded view of the example embodiment of a modular pod lighting system for plants as shown in FIG. 1, wherein the modular pod lighting system for plants does not include plants or tables.

FIG. 3B shows a bottom perspective exploded view of the example embodiment of a modular pod lighting system for plants as shown in FIG. 1, wherein the modular pod lighting system for plants does not include plants or table.

FIG. 4A shows a top perspective view of an example embodiment of reflective light panel, and FIG. 4B shows a bottom perspective view of the same.

FIG. 5A shows a top perspective exploded view of an example embodiment of reflective light panel with the light emitting side of the reflective light panel showing.

FIG. 5B shows a top perspective exploded view of an example embodiment of reflective light panel with the non-light emitting side of the reflective light panel showing.

FIG. 6A shows a top perspective view of an example embodiment of support box, shown without a top panel.

FIG. 6B shows a bottom perspective view of the example embodiment of support box shown in FIG. 6A.

FIG. 6C shows a side profile view of both a male and female reflective light panel mounting grooves.

FIG. 7A shows a top perspective view of an example embodiment of reflective light engine, wherein the light emitting side is shown.

FIG. 7B shows a top perspective view of an example embodiment of reflective light engine, wherein the non-light emitting side is shown.

FIG. 8A shows a top perspective view of an example embodiment of a light reflection apparatus for plants, wherein the apparatus is engaged with plants.

FIG. 8B shows a top view of the example embodiment of a light reflection apparatus for plants as shown in FIG. 8A.

### DETAILED DESCRIPTION

Indoor horticulture such as growing plants buildings etc. has become a prominent growing method for a variety of plants. Indoor growing may be advantageous, for example, the growing conditions such as temperature, humidity, lighting cycles and pest control may be optimally controlled. Cannabis is one such crop that may benefit from indoor growing, and in fact, the practice has become widespread. Although various embodiments of the invention may be described with respect to cultivating cannabis, this is for illustrative purposes only, and should not be construed to limit the scope of possible applications for the various embodiments of the invention. The written descriptions may use examples to disclose certain implementations of the disclosed technology, including the best mode, and may also to enable any person skilled in the art to practice certain implementations of the disclosed technology, including making and using any devices or systems and performing any incorporated methods. The patentable scope of certain implementations of the disclosed technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

The words “stem” or “shoot” may be used interchangeably. Example embodiments of plant reflectors herein described may fit on any suitable appendage of a plant, and the use of the words “stem” or “shoot” should not be construed to limit this generality.

There may be drawbacks of current lighting systems in use for indoor horticulture, both with LED systems and traditional high pressure sodium or metal halide lamp systems. With all systems, the general configuration may be to utilize very high light output fixtures, and hang them at a relatively high height over the plants. This may be done for several reasons:
1. In order to provide the required light distribution across the desired plant growing area. For example, a 1000 watt HPS light fixture may be hung at many feet above the plants in order to provide a wide enough light cone to cover a average sized row or rows of plants.
2. Higher fixture heights may allow sufficient distance from the plants to eliminate bleaching of the plants due to the considerable heat from the light fixtures as well as light hot spots.
3. Overlapping light cones from adjacent fixtures may be required to give a more uniform light density to the plants.

As a result of the higher light fixture mounting heights and the inverse square law of light, extremely high powered lights may be required to provide adequate light levels at the plant height. These high powered lights may create considerable heat, and generally may require ventilation systems vented to the outdoors. This may create extra energy costs on an ongoing basis as well as higher fit-up costs. Extra cooling may be required in the warmer months to offset the heat from the lights.

A further drawback may be light loss. With the described light fixture configuration, the entire inside of the growing room may be lit, including wall, floors, space between plants etc. This may create a large light loss, as this light is not being utilized by the plants, except for perhaps some minimal reflections from said surfaces. The cost of lighting energy for indoor cannabis cultivation may be one of the largest single expenses in the production of commercial cannabis.

Another drawback may be non-uniformity of the light levels at the plant height. Even with overlapping light from adjacent light fixtures, light non-uniformity may be a relatively large ratio. For cannabis crops for example, this may have a direct and significant negative impact on yields.

Examples embodiments of modular pod lighting systems that will be presented may overcome the drawbacks of current lighting systems as described. With the very high revenue potential for cannabis products, even a small increase in light efficiency and uniformity may significantly increase revenues. A plant lighting system with the following advantages may indeed be novel and increase yields and revenues:
Low brightness, uniformly lit light fixture apertures that may cover the entire growing footprint of the plants, that may be placed close to, or touching the plants. This would largely mitigate the effects of the inverse square law of light, and allow for significantly lower light levels from the fixture aperture.
Reflective light panels that both emits light towards the plants and also reflects light towards the plants that may come from back-scatter from the light diffusers in front of the light source, or light reflected from other external surfaces.
Side reflector curtains attached to opposing sides of the reflective light panels, wherein the reflective curtains may extend to the base of the plants. This may function to capture and recycle to the plants a large amount of otherwise wasted light.
Bottom reflectors facing upwards toward the reflective light panels wherein incident light from the reflective light panel and light reflected by the side reflector curtains may be reflected back to the plants or up to the reflective light panel, which may in turn recycle this light towards the plants.
A tunnel created by the reflective light panel, side reflector curtains and bottom reflectors may allow one or more relatively small low powered fans to create a wind tunnel effect, thereby providing superior ventilation for the plants contained therein, and with less power used.

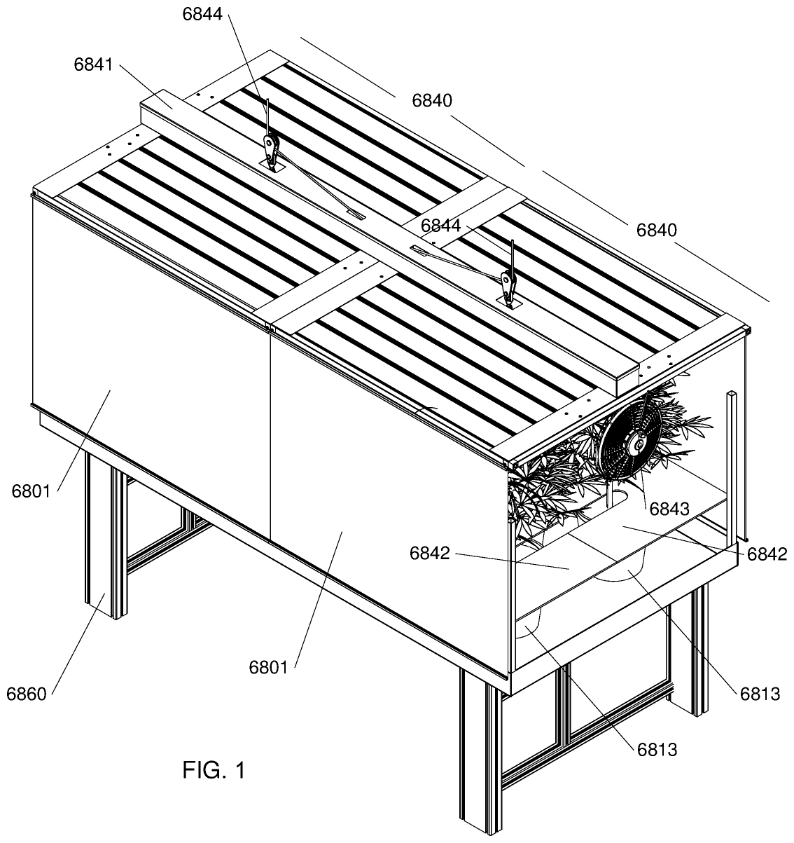

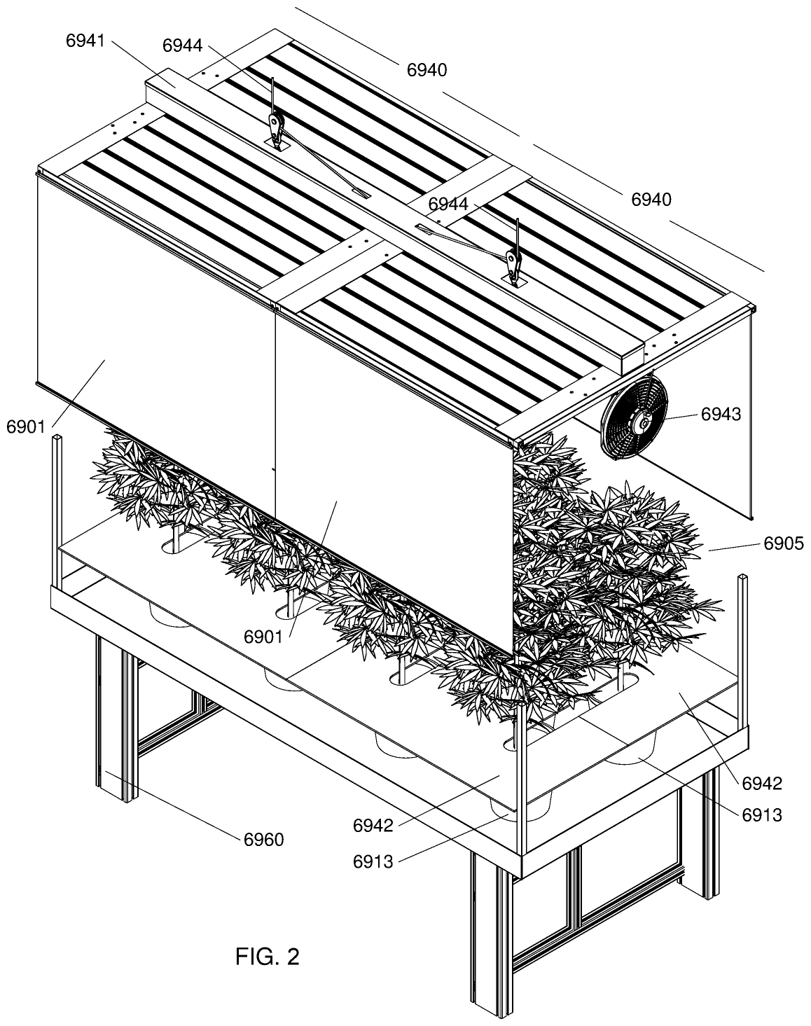

An example embodiment of a modular pod lighting system (herein referred to as “Pod”) is shown in FIG. 1 and FIG. 2. FIG. 1 shows a perspective view of the Pod which may have been lowered into a typical position suitable for growing, and FIG. 2 shows the same Pod but in a raised position, which may be suitable for the inspection and maintenance of the plants.

It should be noted that a grow bench 6860 (FIG. 1) and 6960 (FIG. 2) and plants 6805 with pots 6813 (FIG. 1) and 6905 and 6913 (FIG. 2) may not be part of the claimed invention and may be used for illustrative purposes only. Their use or lack of use should not be construed to create any limitations to the example embodiments herein presented. There may be numerous growing methods in use that may use of variety of different growing equipment and configurations. For example, some growers may not use grow tables, and may assemble the plants on the floor. Some growers may not use individual pots, and may use continuous row containers to contain a grow medium.

Referring to a top perspective view of an example embodiment of POD as shown in FIG. 1, two modular reflective light panels 6840 may be joined together and attached to a support box 6841. Support box 6841 may enclose wiring, electrical components such as LED drivers and a hoist with cables 6844. It should be noted that throughout the drawings the cables 6844 may be depicted as shown for illustrative convenience. In practice, the cables may be long enough to reach a ceiling, and the cables may terminate each with an attachment device such as a hook or carbineer clip to attach the cables to a ceiling attachment point. Modular fan assembly 6843 may be attached to either or both ends of the reflective light panels 6840. Modular fan assembly 6843 may be crucial with respect to proper ventilation of the plants.

Side reflector curtains 6801 may be attached to opposing perimeter edges of the reflective light panels 6840. Plant reflector panels 6842 may lie on the rims of pots 6813. As shown, the described individual basic elements may form an example embodiment of POD wherein a large majority of light may be contained with the POD and subsequently recycled within the POD, thereby minimizing light loss. The effect may be somewhat analogous to a tanning booth for plants, wherein most of the emitted light may be contained within the tanning booth. Although the example embodiment of POD as shown may have two open ends wherein light may escape therefrom, it should be noted that example embodiments of POD are modular. Growers may typically configure their growing setup with long continuous rows of plants, perhaps as long as the building dimensions will allow. If example embodiments of PODs are configured in length to match the plant row lengths as described, for example forty feet in length, then the projected surface area of the two open ends on an example embodiment of POD may become a negligible proportion of the total inner surface area of the POD, wherein the vast majority of light emitted from the reflective light panels 6840 may be recycled within the POD and potentially useable by the plants therein.

A perspective view of the example embodiment of POD from FIG. 1 in its raised position is shown in FIG. 2. Two modular reflective light panels 6940 may be joined together and attached to a support box 6941. Support box 6941 may enclose wiring, electrical components such as LED drivers and a hoist with cables 6944. Side reflector curtains 6901 may be attached to opposing perimeter edges of the reflective light panels 6940. Plant reflector panels 6942 may lay on the rims of pots 6913. Modular fan assembly 6843 may be attached to either or both ends of the reflective light panels 6840.

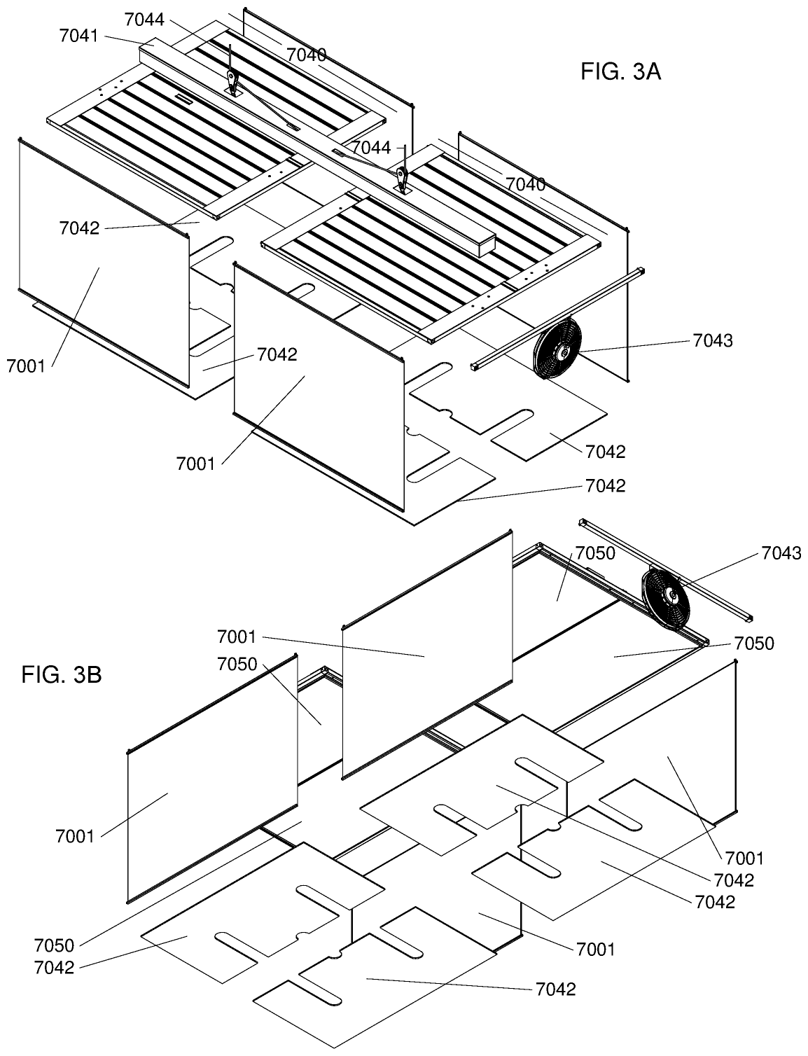

In FIG. 3A, a perspective exploded top view of the example embodiment of POD from FIG. 1 and FIG. 2 is shown, and in FIG. 3B, a perspective exploded bottom view of the example embodiment of POD from FIG. 1 and FIG. 2 is shown. Two modular reflective light panels 7040 may be joined together and attached to a support box 7041. Support box 7041 may enclose wiring, electrical components such as LED drivers and a hoist with cables 7044. Side reflector curtains 7001 may be attached to opposing perimeter edges of the reflective light panels 7040. Plant reflector panels 7042 may lay on the rims of pots (not shown). Modular fan assembly 6843 may be attached to either or both ends of the reflective light panels 7040. Optical film differs panels 7050 may slidingly engage with or otherwise attach to the reflective light panels 7040

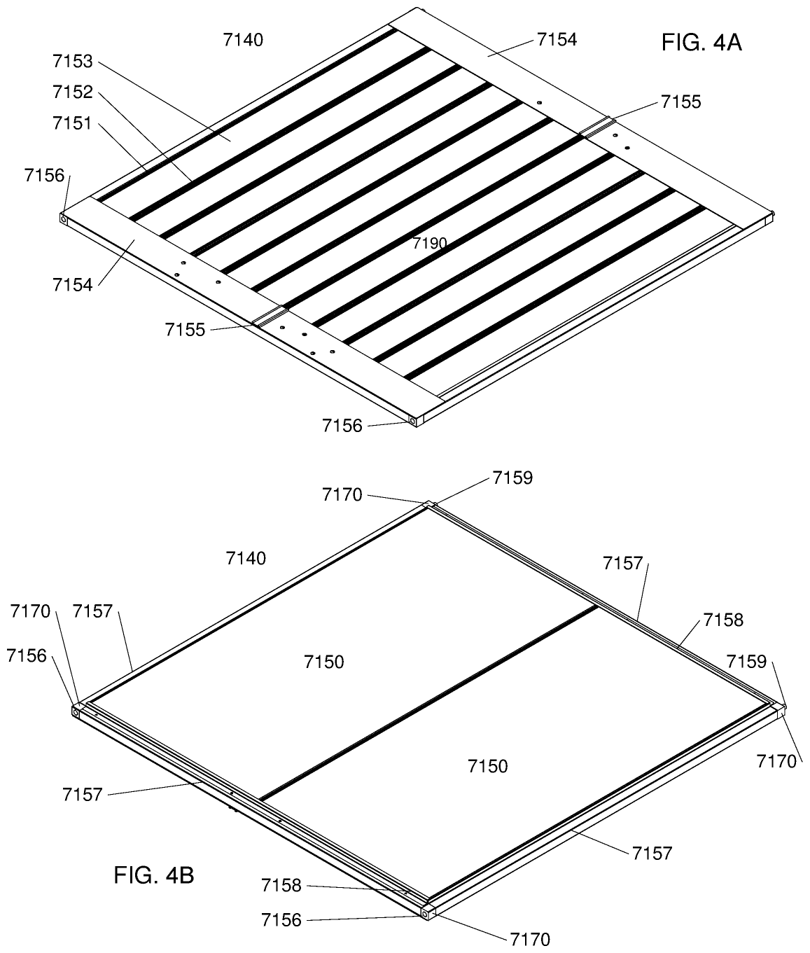

In an example embodiment as shown in FIGS. 4A and 4B, a novel reflective light panel is disclosed. A panel that can reflect as well as emit light may have several advantages which may function to increase overall light efficiency and decrease light loss. The light emitting side of reflective light panels 7140 may be covered by optical film diffuser panels 7150. The diffuser panels may function to diffuse and even our hot spots of the light emitted from LED strips (not shown). As may be inherent with any diffusive refraction medium, a certain amount of light from the light source will be reflected back towards the light source from the back of the diffusive refraction medium (“back-scatter”). In many commercial horticulture light fixtures, single LED strips may be mounted on narrow long metal bases and covered by acrylic diffuser lenses. Accordingly, a large percentage of back-scattered light from the back of the acrylic diffuser lens may be directed to the building ceiling, and away from the plants, and lost. The aperture of other commercial horticulture light fixtures may be completely covered in LED panels or LED strips and covered by one or more diffusers, which may lead to the same type of light loss. Additionally, in other commercial light fixtures, any light reflected back from external surfaces such as white pained floors may be predominantly lost. These disadvantages may be overcome by an example embodiment of novel reflective light as shown in FIGS. 4A and 4B.

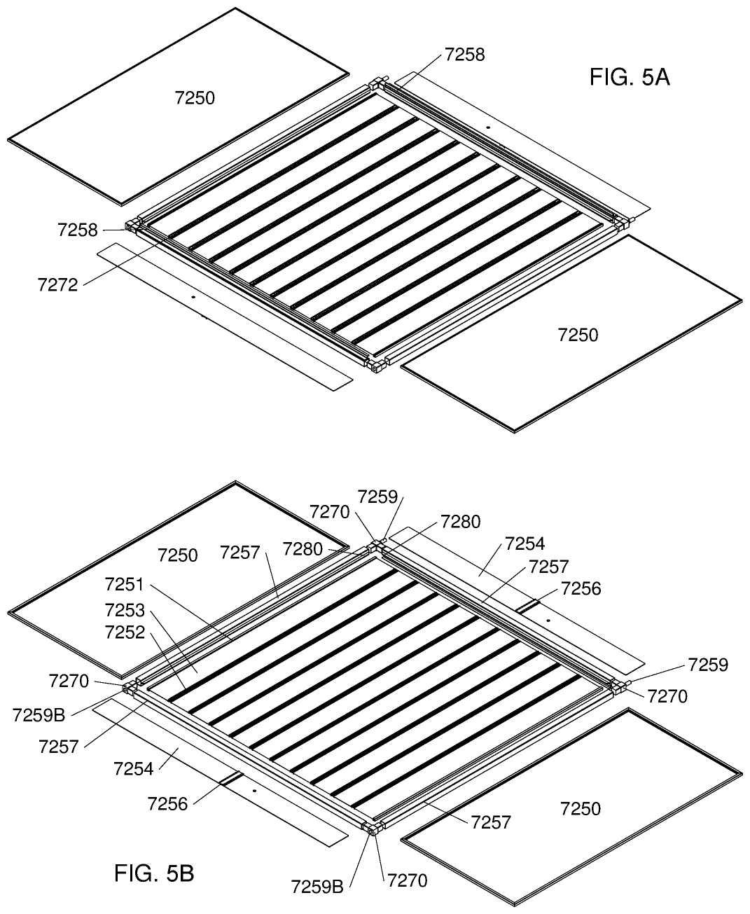

FIG. 4A shows a top perspective view of an example embodiment of reflective light panel, and FIG. 4B shows a bottom perspective view of the same. An outer frame may be fabricated from lightweight aluminum square tubing utilizing frame members 7157 and corner connectors 7170. It may be preferable if the frame members 7157 had an inner ledge fabricated into their profile design such as shown in FIG. 5B features 7280, wherein an inner edge may enable the support of a reflective light engine 7190. Other suitable outer frame assemblies may be also utilized other than those described.

The reflective light engine 7190 may be configured from repeating reflective film pieces 7153 joined to LED heat sinks 7152 with two outer opposing light engine frame pieces 7151. The reflective film 7553 may comprise any reflection film previously discussed in this application, or related applications. The reflective film pieces 7153 (corresponding to FIG. 42A 4201B) may be configured with edge trusses 7575 (corresponding to FIG. 42A 4202) configured from folds 7577 along each of the long edges of the reflector film pieces 7553 (corresponding to FIG. 42A 4203), wherein the edges of the edge trusses 7575 formed on the reflector film pieces 7553 (corresponding to FIG. 42A 4221) may engage with the edge truss retention feature of the light engine frame pieces 7576 and LED heat sink edge truss retention features 7586 (corresponding to FIG. 42A 4220). Any other suitable or practical frame pieces and methods of attachment of the reflector panel to the frame pieces may also be utilized.

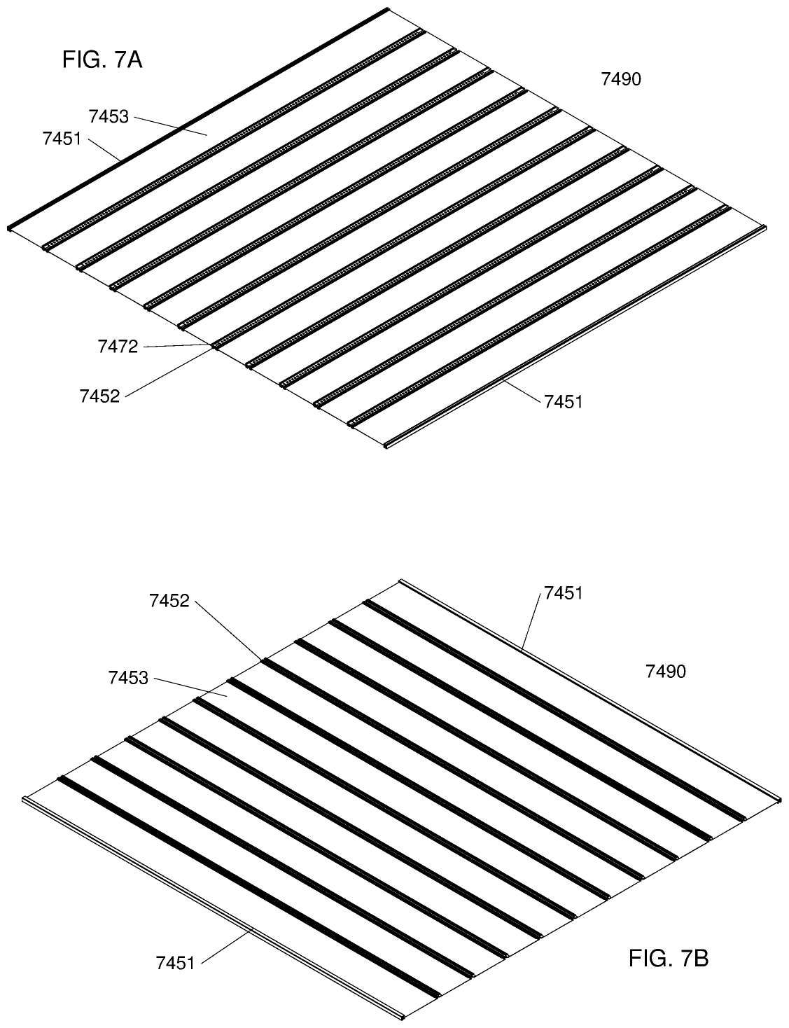

FIG. 7A shows a perspective view of the light emitting side of the light engine 7490, and FIG. 7B shows a perspective view of the back side of the light engine 7490. LED heat sinks 7452 are interconnected with reflection film pieces 7453 and outer light engine frame pieces 7451, and LED strips 7472 may slide into channels configured into LED heat sinks 7452.

FIG. 5A shows an exploded perspective view of the top side of an example embodiment of reflective light panel, and FIG. 5B shows an exploded perspective view of the light emitting side of the same example embodiment of reflective light panel. Referring FIG. 5A, diffuser panels 7250 may be fabricated similarly to those described, or may be fabricated in other configurations, such as sheets of diffusive, non-diffusive or prismatic acrylic sheets. Diffuser panels 7250 may slidingly engage inside channels in opposing diffuser attachment guides 7258. This attachment arrangement may be beneficial wherein easy removal of the diffuser panels for cleaning may save in labor costs.

Referring FIG. 5B, outer frame members 7257 may be connected together with connectors 7220. Connectors 7220 may comprise locking dowel receiving holes 7259B which may accept locking dowels 7259, which may allow reflective light panels to be interconnected. Diffuser panels 7250 may slidingly engage with mating diffuser attachment groves 7258. Wiring cover panels 7254 may function to hide and contain the wires emanating from the LED strips 7272, as well as adding additional rigidity to the outer frame members 7257.

Referring to FIG. 1, in an example embodiment, the side reflector curtains 6801 may be novel additions to the reflective light panels 6840. They may be fabricated with a top and bottom frame member, and may be fabricated in a similar way to that shown and described referencing FIGS. 64A and 65A. A top frame member may enable reliable attachment points to the reflective light panels 6840, and a bottom frame member may allow the reflector curtains 6801 to remain taught. The reflection material may be any material which may reflect light, however reflection materials described in this application as well as related applications may be preferable. The side reflector curtains 6801 may be comprise other configurations as well. For example, they could be rigid panels of reflection material, or reflection material mounted on outer frames.

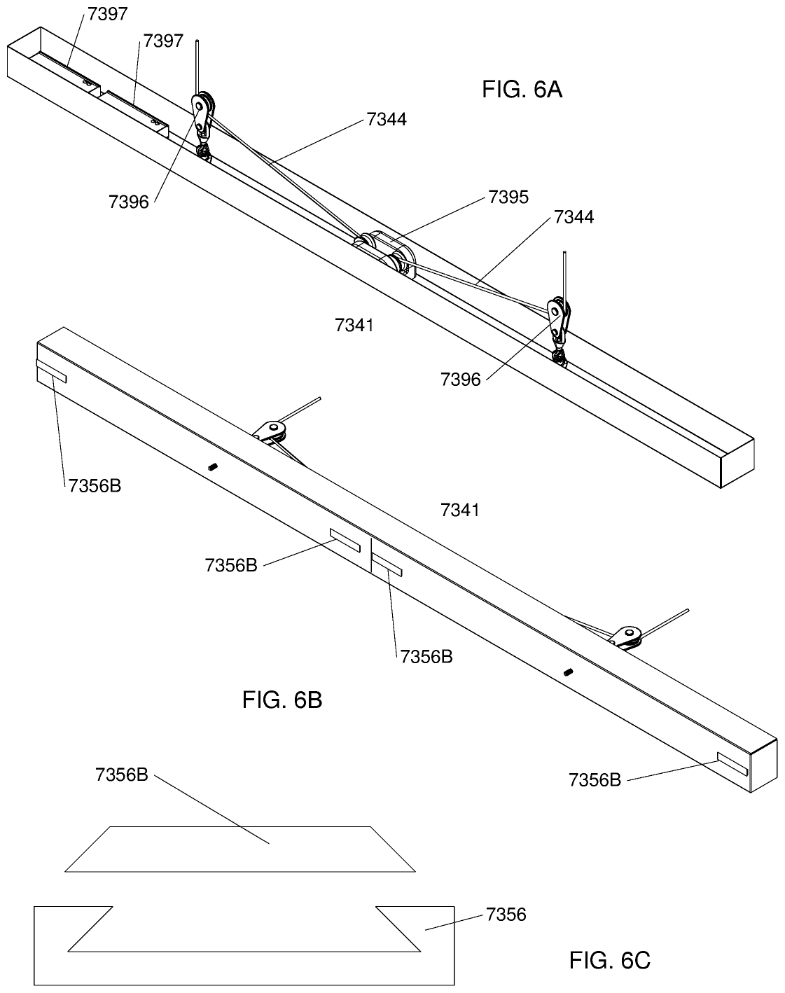

A notable feature is the mating reflective light panel mounting grooves 7256B (FIG. 5B) which may be attached to wiring cover panels 7254. Referring to FIG. 6B, support box 7341 which may enclose wiring, electrical components such as LED drivers and a hoist with cables, may have male light panel mounting grooves 7356B attached as shown. FIG. 6C shows a close-up profile view of the male light panel mounting grooves 7356B and the female light panel mounting grooves 7356. The male light panel mounting grooves 7356B may slidingly engage with female light panel mounting grooves 7356 which may be mounted on wiring cover panels 7254 (FIG. 5B). This mounting method may allow for fast installation and removal of the reflective light panels from the support box 7341.

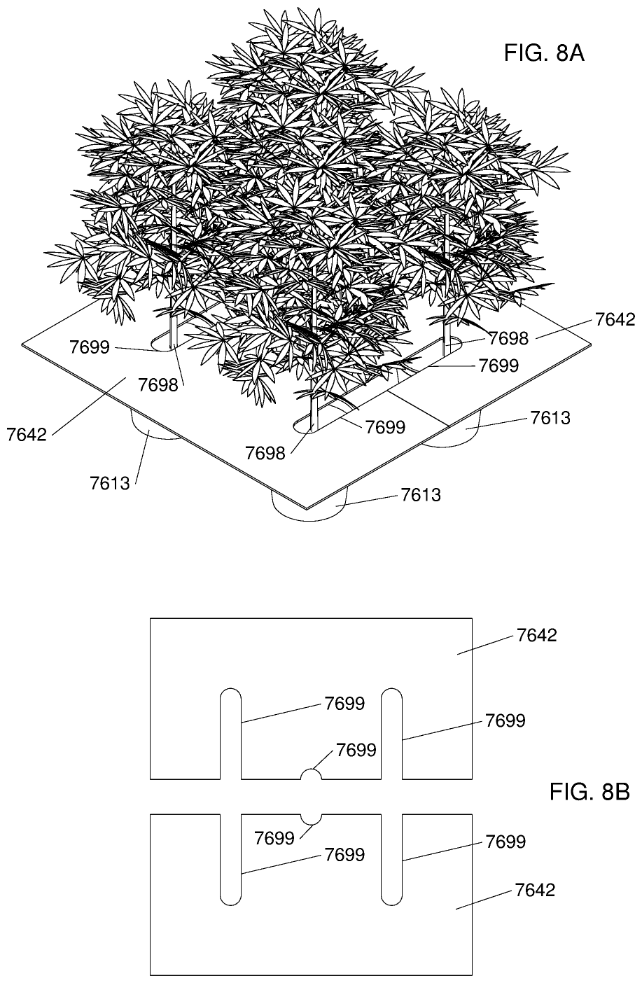

A novel example embodiment of a light reflection apparatus for plants will now be disclosed, and is shown in FIGS. 8A and 8B. Plant reflector panel 7642 may be fabricated from any reflective film, but preferably reflection films (or variations thereof) described in this or related applications. It may be preferable if the reflection film had very high reflective efficiency, perhaps over 97% for example, very high diffuse Lambertian type reflection over 97%, was UV stable, and was impervious to water or humidity. An optional rigid backing substrate may be required to mount the reflection film on in order to provide the required rigidity for a particular application, wherein the reflector panel may remain sufficiently horizontal with acceptable sag. An example of a backing substrate may be corrugated plastic sheets.

Installation slot 7699 may be cut into the reflector panel 7642 using any cost effective means such as steel rule die cutting or flatbed cutting machines for example. The reflection panel 7642 may be installed by sliding plant stems 7698 along the installation slot 7699 until the plant stems 7698 may be disposed within the installation slot 7699 at the desired position. The reflector panels 7644 may be supported on the rims of pots 7613. The reflector panels 7642 dimensions may be fabricated using any suitable dimension for any particular application. Although not shown, clips, brackets, tape, hook and loop fasteners, screws, pins or any other fasteners may be used to help join or secure adjacent panels to each other, which may help keep the reflector panels 7642 disposed in a more level and orderly fashion.

The example embodiment of a light reflection apparatus for plants as shown in FIGS. 8A and 8B may have benefits which may function to lower lighting energy costs and increase yields. Since light from light fixtures or sunlight is predominately directed downwards, a horizontal light reflector as described may reflect and recycle a significant amount of light back towards the plants.

Another notable feature of an example embodiment of light fixture may be the support box 7341 as shown in FIG. 6A. The support box 7341 may comprise a lightweight aluminum box which may function to support and slidingly engage the reflective light panels as previously described. An optional cover (not shown) may cover the support box 7341. The support box may house components such as LED drivers 7397 and hoist 7395.

The hoist 7395 may comprise any suitable electric hoist. However, it may be extremely beneficial that the hoist comprise a lightweight design, can be wirelessly controlled, and self-leveling. Pulleys 7396 may function to redirect the pulley cables 7344 vertically towards the ceiling for subsequent attachment of example embodiments of PODs to the ceiling, and may also lessen the effective pulling force required for the hoist 7395.

As described in example embodiments of modular pod lighting systems, novel advantages have been presented which may increase the light quantity to the plants, thereby increasing yields and revenues. These novel features may comprise
Low brightness, uniformly lit apertures that may cover the entire growing footprint of the plants, that may be placed close to, or touching the plants. This would largely mitigate the effects of the inverse square law of light, and allow for significantly lower light levels from the fixture aperture.
Reflective light panels that both emits light towards the plants and also reflects light towards the plants that may come from back-scatter from the light diffusers in front of the light source, or light reflected from other external surfaces.
Side reflector curtains attached to opposing sides of the reflective light panels, wherein the reflective curtains may fully, or any portion thereof, extend to the base of the plants. This may function to capture and recycle to the plants a large amount of otherwise wasted light
Bottom reflectors facing upwards toward the reflective light panels wherein incident light from the reflective light panel and light reflected by the side reflector curtains may reflected back to the plants or up to the reflective light panel, which may in turn recycle this light towards the plants.
A tunnel created by the reflective light panel, side reflector curtains and bottom reflectors may allow one or more relatively small low powered fans to create a wind tunnel effect, thereby providing superior ventilation for the plants contained therein, and with less power used.

In an example embodiment of the disclosed technology, a modular pod lighting system for plants may comprise a light containment enclosure, which may further comprise a light panel with one side configured to emit light, wherein the light panel may be configured to hang from an above structural element in a relatively horizontal orientation. The modular pod lighting system for plants may further comprise side reflection curtains attached to opposing edges of the light panel, wherein the reflection curtains may extend downwards away from the light panel. The light containment enclosure may be configured to partially enclose plants therein, and wherein light emitted from the light panel may be partially contained and recycled within the light containment enclosure.

In an example embodiment, the plants may further comprise pots that they are contained therein, or plant growing medium containment structures. One or more bottom reflectors configured to reflect light may be disposed on or near the rims of the pots or edges of the plant growing medium containment structures such that their light reflection surfaces may reflect incident light from the side reflection curtains and the light panel.

In an example embodiment, the addition of bottom reflectors may form a more complete light containment enclosure, wherein light emitted from the light panel may be substantially contained and recycled within the light containment enclosure.

In an example embodiment, the light containment enclosure may further comprise a winch system which can raise or lower the light containment enclosure.

In an example embodiment, the light containment enclosure may further comprise a fan assembly attached at one or more ends, wherein the space within the light containment enclosure may function as a partial wind tunnel, wherein air movement caused by the fan assembly may be forced through the constricted space within the light containment enclosure, therein possibly creating greater air movement within the light containment enclosure than would otherwise occur in open space.

In an example embodiment, the light panel may further comprise a reflective light panel or reflective light engine.

In an example embodiment, the side reflector curtains may be rigid or semi rigid reflector panels.

In an example embodiment, the side reflector curtains may further comprise an outer frame.

In an example embodiment of the disclosed technology, a reflective light engine may comprise a light engine comprising a light emitting side, one or more light sources configured to emit light from the light emitting side, and one or more light reflection surfaces on the light emitting side of the reflective light engine.

In an example embodiment, the reflective light engine may further comprise one or more linear elongated heat sinks configured to attach to LED strips, LED strips may be attached to each corresponding one or more linear elongated heat sinks, and reflection material may be attached to one or two sides of the one or more linear elongated heat sinks.

In an example embodiment, the one or more linear elongated heat sinks may further comprise a channel on each opposing side, wherein each channel may comprises a first surface, a second surface that opposes the first surface, and an edge truss retention feature. The reflection material may comprise at least two long edges and a first surface, wherein at least one of the long edges may be configured with at least one edge truss, wherein the at least one edge truss may be configured from a corresponding fold in the reflection material that extends along all, or a portion of the corresponding long edge of the reflection material. At least one edge truss may be configured at an angle relative to the first surface of the reflection material, and wherein the outermost edge of the at least one edge truss may comprise an outer perimeter edge. The reflection material may be configured for attachment to the one or more linear elongated heat sinks such that the at least one edge truss of the reflection material may nest inside a corresponding channel of the one or more linear elongated heat sinks, and the perimeter edge of the at least one edge truss may be engaged by the corresponding channel's edge truss retention feature such that the at least one edge truss may become lodged and secured within the corresponding channel of the one or more linear elongated heat sinks.

In an example embodiment, the reflective light engine may comprise multiple light sources which may be interconnected with corresponding multiple strips of the reflection material, therein forming a reflective light engine.

In an example embodiment of the disclosed technology, a light reflector for plants comprises a piece of reflective material, a top side that comprises the reflective material, and a bottom side configured to be supported on plant pot rims or edges of plant growing medium containment structures. An optional backing substrate attached to the reflective material may help keep the reflective material relatively level when disposed in a horizontal position. Installation slots may be configured in the light reflector for plants, wherein the installation slots are configured to engage or border on plant stems, shoots or trunks, wherein after installation, the light reflector for plants may be horizontally disposed on plant pot rims or on edges of plant growing medium containment structures, wherein plant stems, shoots or trunks may protrude upwards through the installation slots.

In an example embodiment, the light reflector for plants may further comprise adjacent light reflectors that may be joined together utilizing clips, brackets, tape, hook and loop fasteners, screws, pins or any other fasteners.

I claim:

1. A modular pod lighting system for plants comprising:
A light containment enclosure comprising:
a light panel with one side configured to emit light, wherein the light panel is configured to hang from an above structural element in a relatively horizontal orientation; and
side reflection curtains attached to opposing edges of the light panel, wherein the reflection curtains extend downwards away from the light panel;
wherein the light containment enclosure is configured to partially enclose plants therein, and wherein light emitted from the light panel is partially contained and recycled within the light containment enclosure.

2. The light containment enclosure of claim 1, wherein the plants further comprise pots they are contained in, or plant growing medium containment structures, and one or more bottom reflectors configured to reflect light are disposed on or near the rims of the pots or edges of the plant growing medium containment structures such that their light reflection surfaces reflect incident light from the side reflection curtains and the light panel.

3. The light containment enclosure of claim 1 further comprises a raising and or lowering system which can raise or lower the light containment enclosure.

4. The light containment enclosure of claim 1 further comprises a fan assembly attached at one or more ends, wherein the space within the light containment enclosure functions as a partial wind tunnel, wherein air movement caused by the fan assembly is forced through the constricted space within the light containment enclosure, therein creating greater air movement within the light containment enclosure than would otherwise occur in open space.

5. The light panel of claim 1 further comprises a reflective light panel or reflective light engine.

6. The side reflector curtains of claim 1 are rigid or semi rigid reflector panels.

7. The side reflector curtains of claim 1 further comprise an outer frame.

8. The side reflector curtains of claim 1 comprise reflective optic film.

9. A reflective light engine comprising:
a reflective light engine comprising:
a light emitting side;
one or more light sources configured to emit light from the light emitting side; and
one or more light reflection surfaces on the light emitting side of the reflective light engine.

10. The reflective light engine of claim 9 further comprises:
one or more linear elongated heat sinks configured to attach to LED strips;
LED strips attached to each corresponding one or more linear elongated heat sinks; and
reflection material attached to one or two sides of the one or more linear elongated heat sinks.

11. The reflective light engine of claim 9, wherein multiple light sources are interconnected with corresponding multiple strips of the reflection material, therein forming a reflective light panel.

12. A light reflector for plants comprising:
a piece of reflective material;
a top side that comprises the reflective material, and a bottom side configured to be supported on plant pot rims or edges of plant growing medium containment structures;
an optional backing substrate attached to the reflective material to help keep the reflective material relatively level when disposed in a horizontal position; and
installation slots configured in the light reflector for plants, wherein the installation slots are configured to engage or border on plant stems, shoots or trunks;
wherein after installation, the light reflector for plants may be horizontally disposed on plant pot rims or on edges of plant growing medium containment structures wherein plant stems, shoots or trunks protrude upwards through the installation slots.

13. The light reflector for plants of claim 12, wherein adjacent light reflectors may be joined together utilizing clips, brackets, tape, hook and loop fasteners, screws, pins or any other fasteners.
